(19) United States
(12) Patent Application Publication
(10) Pub. No.: US 2003/0074179 A1
(43) Pub. Date: Apr. 17, 2003

(54) Memory-card device for transferring information between the memory-card slot of an application device and a wireless terminal

(75) Inventors: Pekka Ropo, Jyvaskyla (FI); Ari Potkonen, Kangasala (FI)

Correspondence Address: COHEN, PONTANI, LIEBERMAN & PAVANE, 551 FIFTH AVENUE, SUITE 1210, NEW YORK, NY, 10176, US

(73) Assignee: Nokia Corporation

(21) Appl. No.: 10/266,430

(22) Filed: Oct. 8, 2002

(30) Foreign Application Priority Data
Oct. 12, 2001 (FI) FI 20011985

(51) Int. Cl. G06F 9/455

(52) U.S. Cl. 703/27

(57) ABSTRACT

A memory-card device for transferring information between the memory-card slot (27) of an application device (25) and a wireless terminal device (24), in which the memory-card device (10) is fitted to the memory-card slot (27) by means of connecting devices (16) and to which at least memory devices (11, 14) are fitted for storing information. The memory-card device (10) is arranged in the memory-card slot (27) essentially to simultaneously emulate a memory card and transfer information between the application device (25) and the wireless terminal device (24) connected to a data network (23) and that the memory devices (11) are dimensioned according to the information storage unit of the application device (25).

### FIELD OF THE INVENTION

The present invention relates to a memory-card device for transferring information between the memory-card slot of an application device and a wireless terminal, in which the memory-card device is fitted to the memory-card slot using connecting devices and to which at least memory means are fitted for storing the information.

### BACKGROUND OF THE INVENTION

Nowadays, most portable application devices, for example, those classified in the consumer electronics category, such as printers, digital cameras, MP3 music players, and small palm computers, incorporate an extension slot providing a connection for a postage-stamp-sized flash-memory card.

Flash cards are small and easily carried by the user and can be placed in the expansion slot of an application device, so that it is possible to utilize, for example, various applications, content such as image and video cuts, and storage possibilities and back-up copying recorded on the flash-memory card, for which state-of-the-art flash cards provide capacities ranging from a few megabytes to as much as a gigabyte. The wide acceptance of the technology means that the same cards can be used in many consumer electronics application devices presently on the market.

However, particularly the limited storage capacity properties of flash cards cause problems when using such application devices. In addition to this drawback, some of the older models of digital cameras, for example, cannot utilize flash cards larger than 8 MB, so that when buying a new flash card the flash-memory card's compatibility must be checked, for instance, from the device's use instructions, or from the importer.

Additionally, loss or destruction of a flash card nearly always leads to the loss of the material recorded on it.

The erasing of information stored on flash cards between photographing sessions, in order to increase the card's storage capacity, for example, in the case of a digital camera, often does not have the desired effect when using older cameras, for instance. In older cameras, the memory is generally arranged as a single totality, which it is practically impossible to process dynamically, as the card is filled by a new shot being added after the memory area reserved by the previous shot. For example, if an unsuccessful shot is deleted between the other shots, it is usually impossible to utilize the memory area released by the deleted shot until the entire flash card has been emptied.

Further, additional problems arise from the downloading of information from the flash card, for example, to a computer or similar terminal. Almost without exception, known solutions require software and drivers dedicated to the application device, such as a camera, to permit the transfer of information (i.e. in the case of a camera, images) to a computer, for example, using a USB bus. Further, forwarding the information, for example, as e-mail, demands additional properties in the terminal's software and hardware.

When information is downloaded to a computer, for example, from a flash card removed from an application device, a special flash-card adapter is often required, which allows the data to be transferred, for example, to a portable computer through a PC Card Type II (PCMCIA) bus.

The state of the art is shown, for example, by a wireless PHS modem, which is designed to transfer information stored on a Compact Flash (CF) memory card to a portable terminal, and which is connected either through an adapter or directly to a portable or palm computer, depending on the type of connector slot being used.

Devices according to the state of the art are strongly dependent on the operating system and, need driver files to operate, thus substantially reducing its device and operating-system-independent usability. The use of the system in question also cannot remove the restrictions of the size of flash cards, as the information is downloaded essentially separately from the actual flash card interface of the application device, for example, once the flash card is full. The solution also does not permit the uninterrupted use of the application device, as the flash card must be removed from the application device while information is being transferred.

Further reference is made to the state of the art in PCT Publication No. WO/01/58138, which discloses a special transmission unit for transmitting image data, taken by a digital camera, to a terminal arranged in a wireless data transfer network. The publication discloses a memory-unit emulator to be placed in the standard memory-card slot of a digital camera. In this case, the emulator is principally a physical interface, comprising only standard connector surfaces, because the data produced by the camera is transferred directly to the transmission unit for forwarding. Thus, the memory card itself has no image-storage buffering at all. This places special demands on the transmission unit, for example, in terms of the memory capacity required in it, which makes it difficult, for example, to use conventional mobile terminals for transmitting image data.

### SUMMARY OF THE INVENTION

The present invention is intended to create an essentially new type of flash-card device, by means of which the drawbacks of the state of the art referred to above can be eliminated and which is arranged to be independent of the hardware, operating system, and drivers.

The present invention is directed to a memory-card device for transferring information between a memory-card slot of an application device and a wireless terminal device. The memory-card device comprises a memory device for storing information, and a connecting means, coupled to he memory device, for connecting the memory-card device to a memory-card slot of the application device. The memory device has an information storage capacity sufficient to store information received from an application device. The memory-card device is configured so that upon connection of the memory-card device to the memory-card slot of the application device, the memory-card device essentially simultaneously emulates a memory card of the application device to enable transfer of information between the application device and the wireless terminal device connected to a data network.

The use of the flash-card according to the invention permits an essentially improved driver and terminal-independent information storage capacity in an application device, directly through a standard flash-card interface. The use of a flash card emulating the flash-card interface of the application device permits control of the storage of the information produced by the application device, by utilizing a wireless terminal connected to the flash-card to send information on to the file system of a remote terminal device connected to a data network, and back again. The memory card device according to the invention includes the buffer memory required by the information storage unit of the application device.

The use of the flash-memory card device according to the invention achieves benefits, not only in the form of the elimination of flash-card storage capacity limitations and driver compatibility problems, but also of the almost real-time transfer of information produced by the application device, within the framework of the data network and the transfer capacities of the terminal devices. The flash card can also be advantageously used in, for example, old digital cameras, which are difficult to use due to the limited size of flash cards.

If the flash card is broken or lost, the information produced using the application device can be found from the remote terminal that received it. The flash card according to the invention is equally suitable for receiving and for transmitting information. Other characteristic features of the flash card according to the invention are apparent from the accompanying claims.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a schematic diagram of one embodiment of the flash card according to the invention;

FIG. 2 shows an embodiment of the use of the flash card according to the invention; and

FIG. 3 shows a schematic diagram of another embodiment of the flash card according to the invention.

### DETAILED DESCRIPTION OF THE PRESENTLY PREFERRED EMBODIMENTS

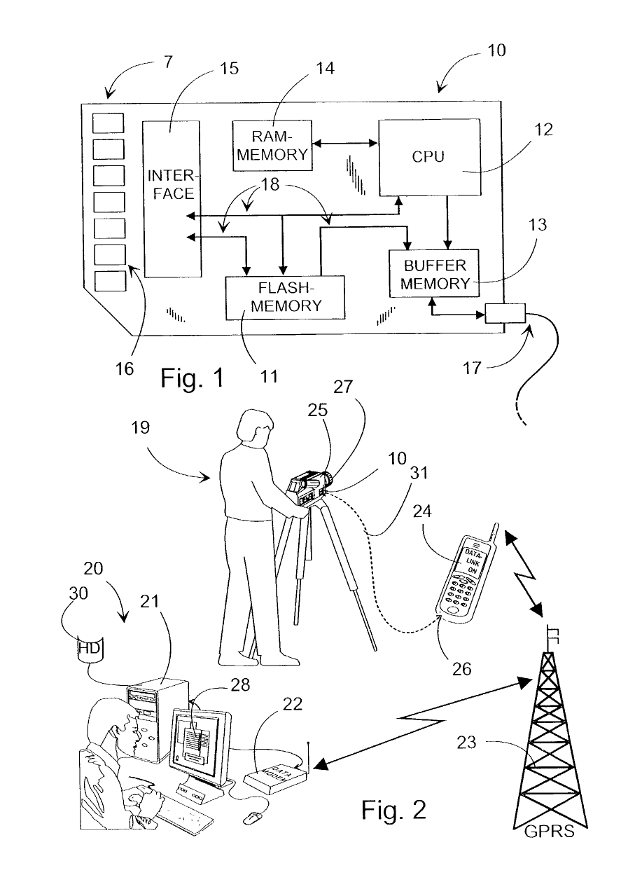

FIG. 1 shows a schematic diagram of an example of a flash-memory card device 10 according to the invention, which hereinafter will also be more briefly referred to as a flash card. The physical manner of connection 16 of the card 10 can be preferably arranged to be fully compatible with the flash-card connections forming the standards according to the state of the art.

According to the invention, the data-transfer interface 15 of the flash card 10 is arranged in such a way that the flash card 10 emulates programmatically a flash card according to the standard, so that the application device (for example, a digital camera) will recognize it as a conventional flash card.

The physical construction of the flash card 10 includes a processor unit (CPU) 12, which, among other things, controls the processing of the information produced by the application device and is also essentially responsible for the emulation of the flash-card interface. The updatable and high-speed flash memory 11 fitted to the flash card 10 is, as such, generally known from conventional flash cards and is arranged on the card 10 to form a sufficient storage reserve for the information produced by the application device and possibly for the settings data of the flash card 10. Part of the flash memory 11 can also be reserved for so-called buffer memories, the size of which is arranged to be set, for example, on the basis of the size of the data packets transferred through the data network 23 (FIG. 2). The buffer memory 13 can also be arranged to form its own unit, separate from the flash memory 11, as shown in FIG. 1. The card device 10 also has buses 18, over which data is transferred between the various components of the card.

The settings data are, for example, collected to form a single file, to store which a separate RAM memory area 14 can be arranged, depending on how the flash card 10 is implemented. The settings files can be preferably configured, for example, using a remote terminal 21 over the data network 23 shown in FIG. 2, the terminal being, for example, the same that is set to receive and store the information produced by the application device 25.

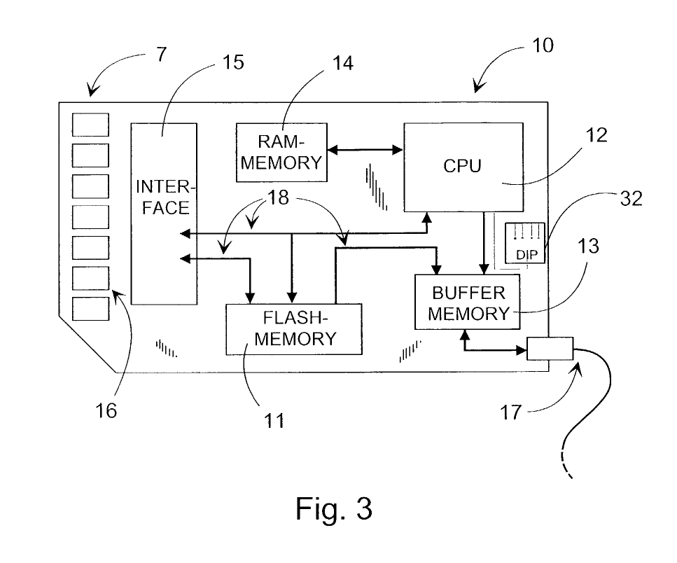

The settings can include the telephone number, i.e. subscriber identifier, of the provider of the data communications connection, the IP address of the server 21 (FIG. 2), and the directory path of the file system 28 located on it, on which the information produced by the application device 25 is stored. The settings can be recorded and be configurable later using the various connection methods, as a text file, as a markup language file, such as WML or HTML, or they can also be arranged to be configurable by means of a mechanical dip-switch arrangement 32, shown in FIG. 3, fitted to the flash card 10. All three settings modes according to the example are equally good and can be used in parallel, so that they can also have the same value in terms of settings content.

FIG. 2 shows an embodiment of the flash card 10 according to the invention. In it, the editorial office 20 of a newspaper has several photographers 19 around the world, who take photographs and transmit the news material to the editorial office 20 for publication in the paper.

The photographer 19 places a flash card 10 according to the invention in the flash-card slot 27 of his digital camera 25 and, once he has found a subject for the photograph and switched on power to the camera 25, carries out known initial procedures, for example, optical focussing. When the camera 25 is switched on, it indicates that the amount of memory available is, for example, one gigabyte, which can be advantageously achieved by means of the flash card 10 according to the invention. The photographer 19 and the camera 25 are informed by means of a preset signal (e.g. BUSY) that the flash card is not yet ready to store information produced by the camera 25, until the flash card 10 has completed its start-up preparations or performed the reset function.

Various operating modes arranged in the memory 11, 14 of the flash card 10 according to the invention can be preferably selected for the card, for example, using a mechanical dip-switch arrangement 32, shown in FIG. 3. Other more preferred ways of selecting operating modes or configuring the settings are wireless means of connection, for example, WAP over Bluetooth, HSPD (High Speed Packet Data), and GPRS (General Packet Radio Service). In such cases, dip-switches are unnecessary, as the operating mode of the card can be set and configured, for example, through Bluetooth technology using the interface of the terminal 24. Bluetooth technology is generally based on a short-range radio connection. The following describes, by way of example, four different alternative possible operating modes of the flash card 10.

In the first and second operating modes, the flash card 10 is arranged to form a connection to the file system 28 of the remote terminal 21 connected to the data network 23, as soon as power is switched on in the digital camera 25. The first settings-file-free operating mode is compatible with all application devices 25 and the settings in it are fixed, so that they can be changed using the terminal 24, for example over the Bluetooth connection, while the application device 25 is operating.

In the second operating mode, the settings files are also displayed through the flash-card interface 15, when they can be configured. Both the first and the second operating mode permit the file system 28 content, which is in reality located in the remote terminal 21, to be operated through the flash-card interface 15 and indicate, after the successful creation of a connection, that the flash card 10 is in a ready state to transfer information.

In the third file-management operating mode, the photographer 19 processes virtually the files stored in the flash card's 10 RAM or flash memory 11, 14, for example, using the interface of his digital camera 25, or the Web browser or editor of his portable computer (not shown), or by means of some other software application. The photographer's 19 operations, directed to one or several files, are then implemented immediately by the remote terminal 21. This permits the information stored virtually on the flash card 10 to be altered dynamically during the connection. All devices may not necessarily be able to operate in this mode.

In the fourth so-called configuration mode, only the configuration files are displayed, and in this case a connection to the remote terminal 21 is not formed. The configuration files can, however, be edited, for example, over WAP over Bluetooth, HSPD, or GPRS connections.

According to one preferred embodiment, the flash card 10 according to the invention operates in practice in such a way that a control program run by the processor unit 12 arranged for the memory devices 11, 14 of the card 10 performs, in connection with the start-up of the camera 25, the first operating mode, which has been selected, for example, using the dip-switch arrangement 32 described above, and in which a data-transfer connection is opened from the wireless terminal, i.e., mobile station 24 arranged in connection with the flash card 10 to the terminal arranged in connection with the data network 23—in the case in the example the server 21 of the newspaper's editorial office 20. Once the connection has been opened, the file system 28 located in the server 21 is made available for display and operation in the camera 25, i.e., the setting data and the file system 28 located physically in the server 21 are displayed through the flash-card interface 15, as if they were located on a conventional flash card.

Once the connection has been successfully opened and the file system 28 of the server 21 has been set to be displayed through the flash card 10, the camera 25 is notified of the amount of available free memory and given a signal to perform the tasks relating to the readiness of the flash card 10.

The file system 28 can in reality be a file structure arranged in a wireless data network 23, or a sub-branch of it, which can be seen and operated through the flash-card interface 15. A mobile network 23, such as a GSM, GPRS, or other preferred 3G architectures permitting data transfer, can be used as the data network 23.

Once the card 10 has notified that it is ready, the photographer 19 can begin to photograph the selected object. The camera 25 begins to feed the information through the flash-card interface 15 to the flash-card 10 according to the invention, which stores it in its flash memory 11, which is arranged on the card 10 in such a way that its size is adapted to the transfer capacity of the data network 23 and the requirements of the photographer 19, for example to be 8 MB. The minimum storage capacity of the memory devices 11 can be dimensioned according to the storage unit required by the image taken by the camera 25. The processor unit of the card 10 controls the processing of the information flow coming from the camera 25, in such a way that data packets of the size of the set criterion are formed from the information stored in the flash memory 11 and transferred to the buffer memory 13.

From the buffer memory 13 of the card 10, the data packets are addressed, for example, using a wireless infrared link 31 to a wireless terminal carried, for example, in the photographer's pocket or in a similar holder, through its IR connection 26, in which the wireless terminal is, for example, a mobile station 24 according to a GSM or preferably a packet-switched GPRS or 3G standard. An alternative and easier manner of data transfer is to use, for example, Bluetooth technology, or a data-transfer method based on some other similar wireless local area network architecture. Bluetooth also operates advantageously in cases, if the application device, in which the flash card 10 is closed and there are visual obstacles between it and the terminal 24. Alternatively, data can be transferred over an intermediate cable between the flash card 10 and the mobile station 24. As the data transfer progresses from the flash card 10 to the wireless terminal 24 and onward to the data network 23, the amount of free space displayed by the flash card 10 to the camera 25 is updated.

When using, for example, a terminal 24 according to the GPRS standard, the data transfer can be arranged to take place according to the amount of data produced by the camera 25. Thus, the GPRS connection is only activated when there is a need for transfer, at other times the card 10 and the remote computer 21 can advantageously be in a stand-by state and only notify the data network 23 at intervals that they are still operative. This achieves a considerable saving in transfer costs, because in the connection costs are then based on the actual amount data transferred.

The reservation of the memory can be arranged to take place, for example, to be sufficient for the purpose. It can preferably be arranged according to the wireless data transfer from the wireless terminal 24 to the remote terminal 21. If the data transfer is not steady, for example, due to network overload or some similar factor creating traffic blockages, the amount of memory displayed to the application device 25 can be reduced. If the amount of free memory is exceeded, the camera 25 is notified that the card 10 is full and sent a ‘not-ready’ signal, if the card 10 and in turn the data network cannot transfer the data.

One-time writing and its buffered transmission is a solution that will, as such, work for the flash card 10 according to the invention, assuming that data transfer takes place steadily. In practice this means, for example in the case of a digital camera 25, that, when the photographer 19 uses the camera 25 to take the next picture, the previous picture is transferred simultaneously using a wireless terminal, such as a GPRS telephone 24, to the remote terminal 21, such as the server 21 in the editorial office 20 of the newspaper.

The remote terminal, for example the server 21, is arranged with connection devices 22 either to a wireless terminal 24 transmitting to essentially the same mobile network 23, or, for example, to the Internet network. The server 21 has a storage device, for example, a hard disk HD 30, on which a directory hierarchy 28 is created for the files to be stored. The sever 21 can also have software for processing the received data, or, for example, for converting it into some compressed format that can be interpreted by the software of the server 21, if the data is possibly compressed. The settings of the flash card 10 can also be advantageously changed wirelessly over the air from the server 21.

One preferred embodiment for forming a connection between the transmitting wireless terminal 24 connected to the flash card 10 and the server 21 connected to the data network 23 is arranged to take place by the transmitting terminal 24 connected to the flash card 10 being first set to form a first connection to the server 21, in such a way that the server 21 does not respond to the connection attempt, but instead registers the subscriber identifier used in the wireless terminal 24 that attempted the connection, then breaks off the connection formation attempt when this is obtained. Next, the server 21 forms a second connection with the terminal 24 on the basis of the previously registered subscriber identifier, and opens the connection. The connection formation method depicted allows the costs arising from the information transfer to be concentrated, for example, in the case of several transmitting entities, in the editorial offices 20 of the newspaper.

Besides the aforesaid consumer electronics, one advantageous area of application of the flash card 10 according to the invention that can be mentioned is, for example, maintenance tasks for automatic beverage dispensers and the control of surveillance points, in which in current practice the alarm data is stored in files. In these applications, the data is arranged to be transferred, using a flash card 10 according to the invention, directly to a server, for example. The flash card 10 can also be arranged essentially in connection with the terminal 24, so that the terminal has a connection fitting the flash-card slot 27 of the application device 24 (not shown).

The flash card 10 according to the invention can be advantageously used in the transfer of information taking place in both directions, so that an alternative to the information transfer described in the embodiments, which takes place from the application device 25 (the camera) to the remote terminal 21 (the server), is the information transfer from the remote terminal 21 to the application device, for example, to an MP3 music player.

Thus, while there have been shown and described and pointed out fundamental novel features of the present invention as applied to a preferred embodiment thereof, it will be understood that various omissions and substitutions and changes in the form and details of the devices described and illustrated, and in their operation may be made by those skilled in the art without departing from the spirit of the present invention. For example, it is expressly intended that all combinations of those elements which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A memory-card device for transferring information between a memory-card slot of an application device and a wireless terminal device, comprising:
a memory device for storing information, the memory device having an information storage capacity sufficient to store information received from an application device; and
connecting means for connecting the memory-card device to a memory-card slot of the application device, the memory device being coupled to the connecting means,
wherein the memory-card device is configured so that upon connection of the memory-card device to the memory-card slot of the application device, the memory-card device essentially simultaneously emulates a memory card of the application device to enable transfer of information between the application device and the wireless terminal device connected to a data network.

2. The memory-card device of claim 1, wherein the wireless terminal is a GSM-type or GPRS-type terminal configured for information transfer with a remote terminal connected to a data network.

3. The memory-card device of claim 1, wherein the information storage capacity of the memory device is sufficient to store a current amount of information transferred from the application device.

4. The memory-card device of claim 1, in combination with a remote terminal, the remoter terminal comprising:
receiving means for receiving from the memory-card device information stored in the memory device of the memory-card device;
storage means for storing information received from the memory-card device; and
program means for interpreting the information received from the memory-card device to render the received information capable of being output by the remote terminal.

5. The memory-card device of claim 1, wherein the storage capacity of the memory device of the memory-card device is sufficient to store configurable settings data relating to the transfer of the information.

6. The memory-card device of claim 4, wherein the storage capacity of the memory device of the memory-card device is sufficient to store configurable settings data relating to the transfer of the information.

7. The memory-card device of claim 6, wherein the configurable settings data includes a subscriber identifier and IP address of the remote terminal and a storage path of the information in the storage means of the remote terminal.

8. The memory-card device of claim 6, wherein the memory-card device and the remote terminal are configured so that the remote terminal is capable of configuring the memory-card.

9. The memory-card device of claim 7, wherein the memory-card device and the remote terminal are configured so that the remote terminal is capable of configuring the memory-card.

10. The memory-card device of claims 5, further comprising:
a mechanical switch; and
wherein the settings data are arranged to be configured in the memory-card device by actuating the mechanical switch.

11. The memory-card device of claims 6, further comprising:
a mechanical switch; and
wherein the settings data are arranged to be configured in the memory-card device by actuating the mechanical switch.

12. The memory-card device of claims 7, further comprising:
a mechanical switch; and
wherein the settings data are arranged to be configured in the memory-card device by actuating the mechanical switch.

13. The memory-card device of claim 4, wherein an operating mode of the memory-card device is a direct settings-file-free connection mode, in which:
the memory-card device creates a connection to the storage means of the remote terminal upon activation of the application device; and
the content of the storage means of the remote terminal is accessible by the memory-card device upon creation of the connection of the memory-card device to the storage means of the remote terminal.

14. The memory-card device of claim 6, wherein an operating mode of the memory-card device is a direct settings-file-free connection mode, in which:
the memory-card device creates a connection to the storage means of the remote terminal upon activation of the application device; and
the content of the storage means of the remote terminal is accessible by the memory-card device upon creation of the connection of the memory-card device to the storage means of the remote terminal.

15. The memory-card device of claim 8, wherein an operating mode of the memory-card device is a direct settings-file-free connection mode, wherein:
the memory-card device creates a connection to the storage means of the remote terminal upon activation of the application device; and
the content of the storage means of the remote terminal is accessible by the memory-card device upon creation of the connection of the memory-card device to the storage means of the remote terminal.

16. The memory-card device of claim 1, wherein an operating mode of the memory-card device is a direct settings-file-free connection mode, wherein:
the memory-card device is capable of creating a connection to a storage means of a remote terminal upon activation of the application device; and
the content of the storage means of the remote terminal is accessible by the memory-card device upon creation of the connection of the memory-card device to the storage means of the remote terminal.

17. The memory-card device of claim 6, wherein an operating mode of the memory-card device is a direct connection mode, wherein:
the memory device has stored therein a settings file in which the configurable settings data is stored, the settings file being capable of being transmitted by the memory-card device to the remote terminal for display on a display of the remote terminal.

18. The memory-card device of claim 7, wherein an operating mode of the memory-card device is a direct connection mode, wherein:
the memory device has stored therein a settings file in which the configurable settings data is stored, the settings file being capable of being transmitted by the memory-card device to the remote terminal for display on a display of the remote terminal.

19. The memory-card device of claim 1, wherein an operating mode of the memory-card device is a direct connection mode, wherein:
the memory device has stored therein a settings file in which the configurable settings data is stored, the settings file being capable of being transmitted by the memory-card device to a remote terminal for display on a display of the remote terminal.

20. The memory-card device of claim 4, wherein an operating mode of the memory-card device is a file-management mode, wherein:
the information stored in the remote terminal is displayed on a display of the remote terminal immediately upon receipt of the information from the memory-card device.

21. The memory-card device of claim 1, wherein an operating mode of the memory-card device is a file-management mode, wherein:
the information stored in the remote terminal is capable of being displayed on a display of a remote terminal immediately upon receipt of the information from the memory-card device.

22. The memory-card device of claim 5 6, wherein an operating mode of the memory-card device is a configuration mode, wherein:
only the configurable settings data are capable of being displayed on a display of the remote terminal without creating a connection between the memory-card device and a remote terminal.

23. The memory-card device of claim 5 6, wherein an operating mode of the memory-card device is a configuration mode, wherein:
only the configurable settings data are capable of being displayed on a display of the remote terminal without creating a connection between the memory-card device and a remote terminal.

24. The memory-card device of claim 1, wherein the memory-card device is configured to connect to the wireless terminal employing a wireless local area network architecture, or an IR link.

25. The memory-card device of claim 1, wherein the memory-card device is configured to connect to the wireless terminal with a wire.

26. The memory-card device of claim 1, wherein the memory-card device is mountable to the wireless terminal.
